(19) United States
(12) Patent Application Publication
(10) Pub. No.: US 2025/0208412 A1
(43) Pub. Date: Jun. 26, 2025

(54) WIDE FIELD OF VIEW (FOV) WAVEGUIDE EYE TRACKING SYSTEM

(71) Applicant: Meta Platforms Technologies, LLC, Menlo Park, CA (US)

(72) Inventor: Hsien-Hui CHENG, Woodinville, WA (US)

(73) Assignee: Meta Platforms Technologies, LLC., Menlo Park, CA (US)

(21) Appl. No.: 18/976,090

(22) Filed: Dec. 10, 2024

Related U.S. Application Data
(60) Provisional application No. 63/613,470, filed on Dec. 21, 2023.

(51) Int. Cl. G02B 27/00; G02B 27/01

(52) U.S. Cl. CPC G02B 27/0093; G02B 27/0172; G02B 2027/0138; G02B 2027/0178

(57) ABSTRACT

Augmented and/or virtual reality (AR/VR) near-eye display devices implementing large field of view (FOV) waveguide (WG) eye tracking combined with switchable/tunable optical elements to enable both eye and face tracking are disclosed. In particular, an eye tracking system for an augmented reality/virtual reality (AR/VR) display device may comprise a waveguide, a first deflector element to reflect captured light to propagate in the waveguide, a second deflector element to reflect the propagated light out of the waveguide, an optical element to guide out-coupled light into an eye tracking camera, and a controller to manage the optical element such that a small FOV image of an eye is captured in a first time frame and a large FOV image of a region around the eye is captured in a second time frame.

### PRIORITY

The present application claims priority to U.S. provisional patent application Ser. No. 63/613,470, filed on Dec. 21, 2023, which is incorporated by reference in its entirety.

### TECHNICAL FIELD

This patent application relates generally to augmented and/or virtual reality (AR/VR) near-eye display devices, and in particular, to large field of view (FOV) waveguide (WG) eye tracking combined with switchable/tunable optical elements to enable in field tracking for both eye and face.

### BACKGROUND

With recent advances in technology, prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

To facilitate delivery of this and other related content, service providers have endeavored to provide various forms of wearable display systems. One such example may be a head-mounted display (HMD) device, such as a wearable eyewear, a wearable headset, or eyeglasses. In some examples, the head-mounted display (HMD) device may project or direct light to may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment. Head-mounted display (HMD) devices may also present interactive content, where a user's (wearer's) gaze may be used as input for the interactive content.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality system environment including a near-eye display, according to an example.

FIGS. 2A-2C illustrate various views of a near-eye display device in the form of a head-mounted display (HMD) device, according to examples.

FIG. 3 illustrates a perspective view of a near-eye display in the form of a pair of glasses, according to an example.

FIG. 4 illustrates a waveguide eye tracking system and a waveguide eye tracking system with polarization volume hologram (PVH) deflectors, according to an example.

FIGS. 5A-5C illustrate a waveguide eye tracking system with a switchable/tunable optical lens, according to examples.

FIGS. 6A-6C illustrate a waveguide eye tracking system with a beam steering device, according to examples.

FIG. 7 illustrates an example configuration of a large field of view (FOV) waveguide eye tracking system with polarization tiling, according to an example.

FIGS. 8A-8E illustrate example configurations of large field of view (FOV) waveguide eye tracking systems with spatial tiling, wavelength tiling, and polarization tiling, according to examples.

FIG. 9 illustrates a flow diagram for a method of providing large field of view (FOV) waveguide eye tracking, according to some examples.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Conventional waveguide eye tracking systems can realize a front-view camera for eye tracking to address the issues of population coverage, occlusion, and cost in conventional eye tracking cameras. If the eye tracking system can (partially) track face information, manufacturing cost may be reduced and/or consumed power reduced by the total number of cameras and sensors used in the head-mounted display device (or near-eye display device). In order to make an eye tracking system that partially covers face tracking, larger FOV camera and large FOV waveguide are both required. However, if the camera FOV is increased without increasing pixel number of camera sensor, image resolution may be decreased, and it cannot match precision requirement for eye tracking. If both camera FOV and pixel number of camera sensor are increased, manufacturing cost and power consumption are bound to increase.

In some examples of the present disclosure, large field of view (FOV) waveguide eye tracking may be combined with switchable/tunable optical elements to enable in field tracking for both eye and (partial) face. High resolution small FOV in-field eye tracking and low resolution large FOV face tracking may be accomplished through the use of switchable/tunable optical lenses, beam steering devices, polarization tiling, wavelength tiling, and/or spatial tiling.

While some advantages and benefits of the present disclosure are apparent, other advantages and benefits may include implementation of high resolution small FOV in-field eye tracking and low resolution large FOV face tracking without increasing number of pixels on a camera sensor saving cost and power consumption. Further, waveguide FOV may be increased with increasing weight of the eye tracking system as higher refractive index material may not be needed.

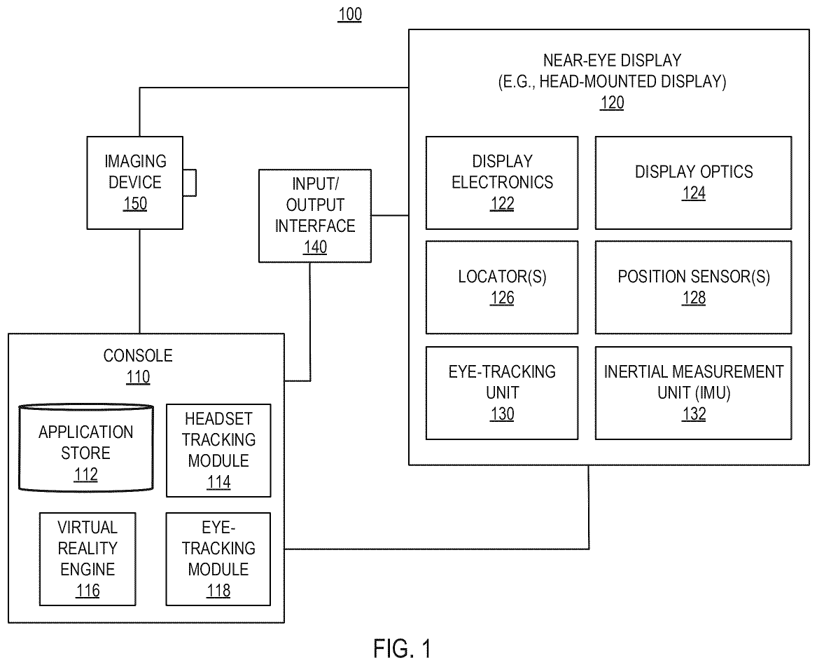

FIG. 1 illustrates a block diagram of an artificial reality system environment 100 including a near-eye display, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements and may include use of technologies associated with virtual reality (VR), augmented reality (AR), and/or mixed reality (MR). As used herein a “user” may refer to a user or wearer of a “near-eye display.”

As shown in FIG. 1, the artificial reality system environment 100 may include a near-eye display 120, an optional external imaging device 150, and an optional input/output interface 140, each of which may be coupled to a console 110. The console 110 may be optional in some instances as the functions of the console 110 may be integrated into the near-eye display 120. In some examples, the near-eye display 120 may be a head-mounted display (HMD) that presents content to a user.

In some instances, for a near-eye display system, it may generally be desirable to expand an eye box, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular head-mounted display (HMD)) or both eyes (for binocular head-mounted displays (HMDs)). Also, as used herein, an “eye box” may be a two-dimensional box that may be positioned in front of the user's eye from which a displayed image from an image source may be viewed.

In some examples, in a near-eye display system, light from a surrounding environment may traverse a “see-through” region of a waveguide display (e.g., a transparent substrate) to reach a user's eyes. For example, in a near-eye display system, light of projected images may be coupled into a transparent substrate of a waveguide, propagate within the waveguide, and be coupled or directed out of the waveguide at one or more locations to replicate exit pupils and expand the eye box.

In some examples, the near-eye display 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

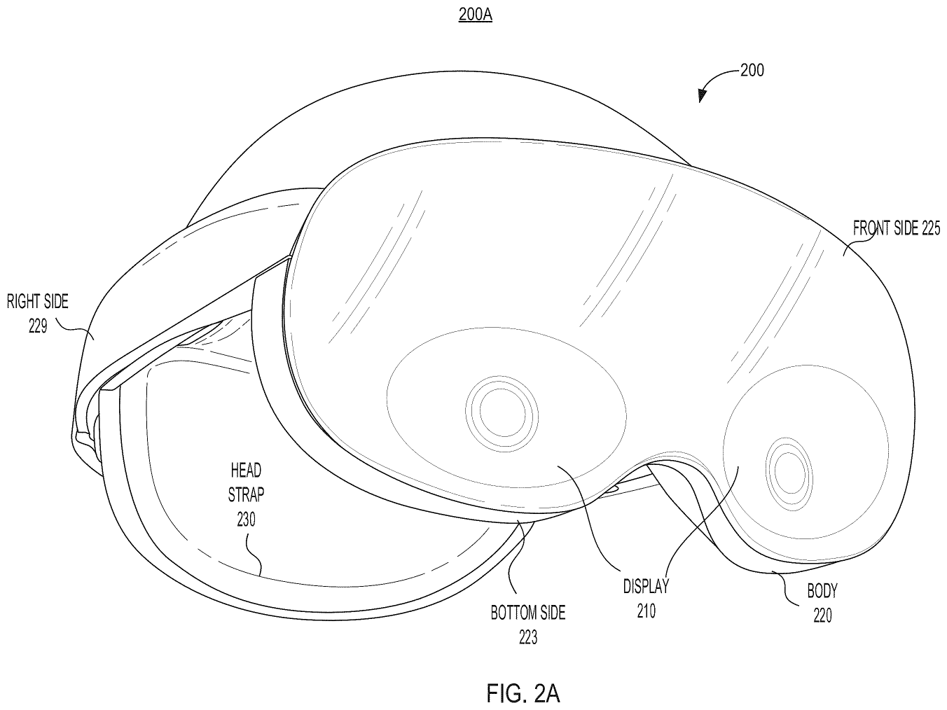

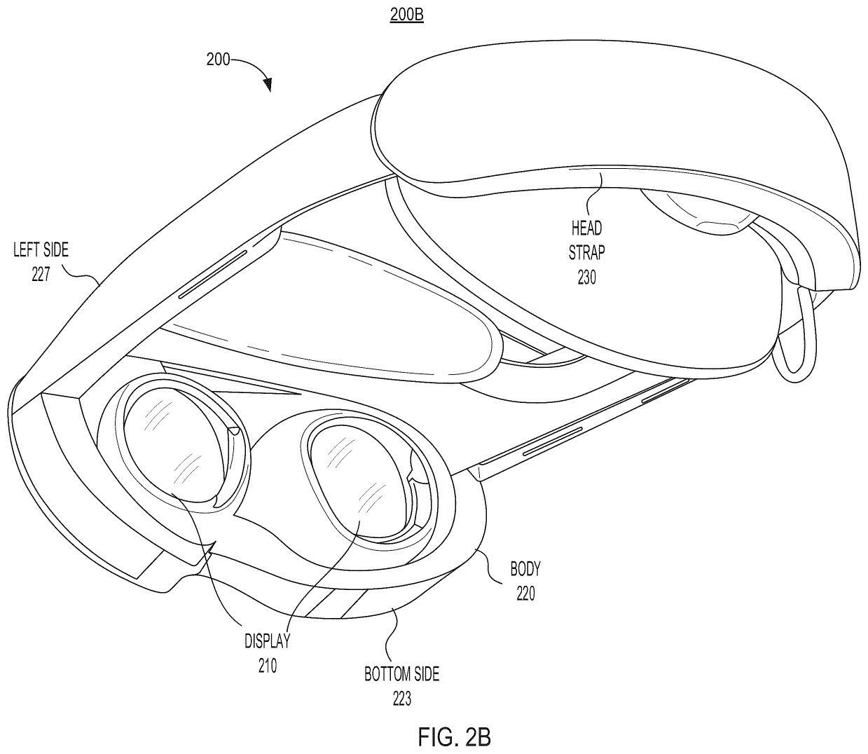

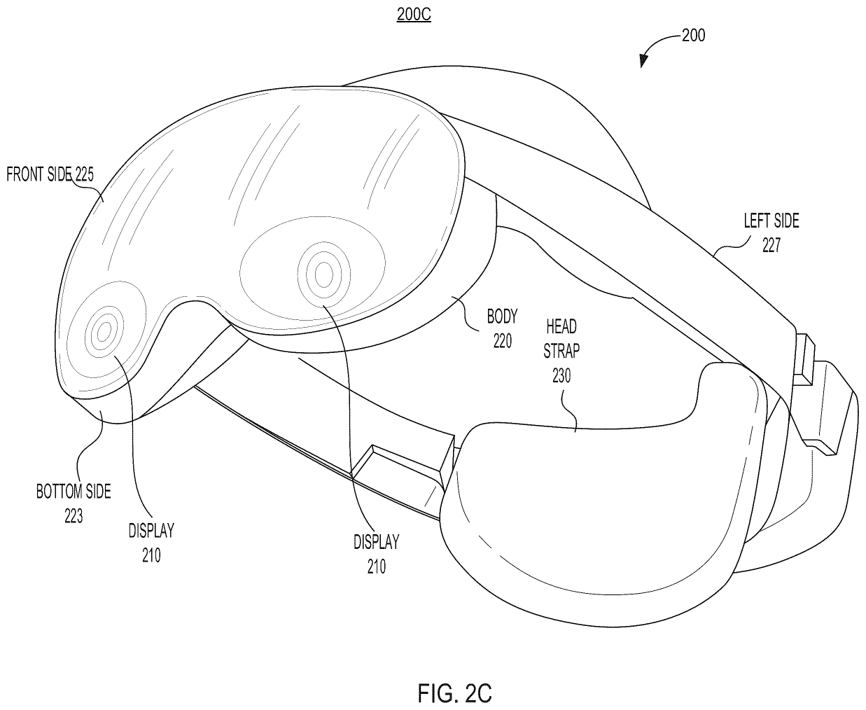

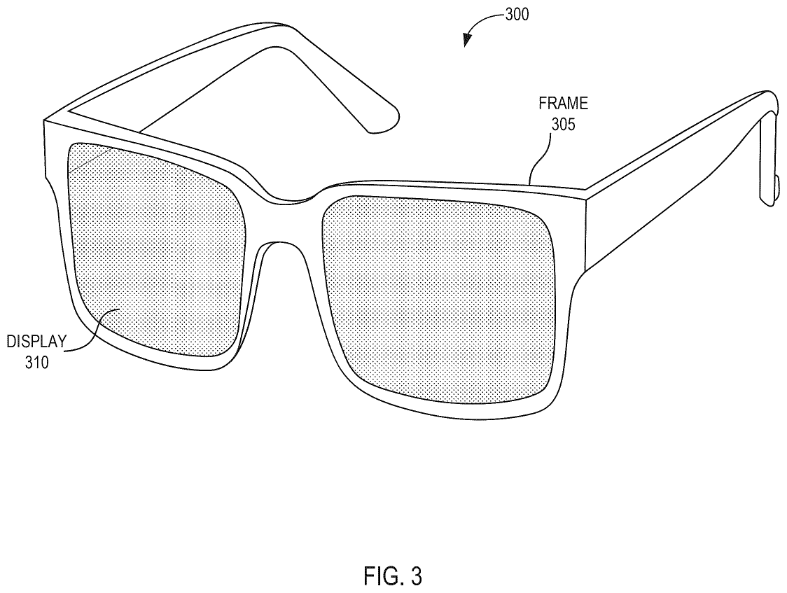

In some examples, the near-eye display 120 may be implemented in any suitable form-factor, including a head-mounted display (HMD), a pair of glasses, or other similar wearable eyewear or device. Examples of the near-eye display 120 are further described below with respect to FIGS. 2 and 3. Additionally, in some examples, the functionality described herein may be used in a head-mounted display (HMD) or headset that may combine images of an environment external to the near-eye display 120 and artificial reality content (e.g., computer-generated images). Therefore, in some examples, the near-eye display 120 may augment images of a physical, real-world environment external to the near-eye display 120 with generated and/or overlaid digital content (e.g., images, video, sound, etc.) to present an augmented reality to a user.

In some examples, the near-eye display 120 may include any number of display electronics 122, display optics 124, and an eye tracking unit 130. In some examples, the near-eye display 120 may also include one or more locators 126, one or more position sensors 128, and an inertial measurement unit (IMU) 132. In some examples, the near-eye display 120 may omit any of the eye tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the near-eye display 120 may include a projector (not shown), which may form an image in angular domain for direct observation by a viewer's eye through a pupil. The projector may employ a controllable light source (e.g., a laser source) and a micro-electromechanical system (MEMS) beam scanner to create a light field from, for example, a collimated light beam. In some examples, the same projector or a different projector may be used to project a fringe pattern on the eye, which may be captured by a camera and analyzed (e.g., by the eye tracking unit 130) to determine a position of the eye (the pupil), a gaze, etc.

In some examples, the display optics 124 may display image content optically (e.g., using optical waveguides and/or couplers) or magnify image light received from the display electronics 122, correct optical errors associated with the image light, and/or present the corrected image light to a user of the near-eye display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube deflector, a reflective marker, a type of light source that contrasts with an environment in which the near-eye display 120 operates, or any combination thereof.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display 120 that may be relative to an initial position of the near-eye display 120. For example, the inertial measurement unit (IMU) 132 may integrate measurement signals received from accelerometers over time to estimate a velocity vector and integrate the velocity vector over time to determine an estimated position of a reference point on the near-eye display 120. Alternatively, the inertial measurement unit (IMU) 132 may provide the sampled measurement signals to the optional console 110, which may determine the fast calibration data.

The eye tracking unit 130 may include one or more eye tracking systems. As used herein, “eye tracking” may refer to determining an eye's position or relative position, including orientation, location, and/or gaze of a user's eye. In some examples, an eye tracking system may include an imaging system that captures one or more images of an eye and may optionally include a light emitter, which may generate light (e.g., a fringe pattern) that is directed to an eye such that light reflected by the eye may be captured by the imaging system (e.g., a camera).

In some examples, the near-eye display 120 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye tracking unit 130 may be able to determine where the user is looking or predict any user patterns, etc.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display 120 for presentation to the user in accordance with information received from one or more of external imaging device 150, the near-eye display 120, and the input/output interface 140. For example, in the example shown in FIG. 1, the optional console 110 may include an application store 112, a headset tracking module 114, a virtual reality engine 116, and an eye tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. It should be appreciated that the optional console 110 may or may not be needed or the optional console 110 may be integrated with or separate from the near-eye display 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display 120 using slow calibration information from the external imaging device 150. For example, the headset tracking module 114 may determine positions of a reference point of the near-eye display 120 using observed locators from the slow calibration information and a model of the near-eye display 120. Additionally, in some examples, the headset tracking module 114 may use portions of the fast calibration information, the slow calibration information, or any combination thereof, to predict a future location of the near-eye display 120. In some examples, the headset tracking module 114 may provide the estimated or predicted future position of the near-eye display 120 to the virtual reality engine 116.

In some examples, the virtual reality engine 116 may execute applications within the artificial reality system environment 100 and receive position information of the near-eye display 120, acceleration information of the near-eye display 120, velocity information of the near-eye display 120, predicted future positions of the near-eye display 120, or any combination thereof from the headset tracking module 114. In some examples, the virtual reality engine 116 may also receive estimated eye position and orientation information from the eye tracking module 118. Based on the received information, the virtual reality engine 116 may determine content to provide to the near-eye display 120 for presentation to the user.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

As mentioned herein, using a tunable/switchable optical element and large FOV waveguide architecture, high resolution small FOV in-field eye tracking and low resolution large FOV face tracking may be implemented without increasing number of pixel on camera sensor to save cost and power. Furthermore, polarization tiling, spatial tiling, and/or wavelength tiling may be used to implement large FOV waveguide eye/face tracking.

FIGS. 2A-2C illustrate various views of a near-eye display device in the form of a head-mounted display (HMD) device 200, according to examples. In some examples, the head-mounted device (HMD) device 200 may be a part of a virtual reality (VR) system, an augmented reality (AR) system, a mixed reality (MR) system, another system that uses displays or wearables, or any combination thereof. As shown in diagram 200A of FIG. 2A, the head-mounted display (HMD) device 200 may include a body 220 and a head strap 230. The front perspective view of the head-mounted display (HMD) device 200 further shows a bottom side 223, a front side 225, and a right side 229 of the body 220. In some examples, the head strap 230 may have an adjustable or extendible length. In particular, in some examples, there may be a sufficient space between the body 220 and the head strap 230 of the head-mounted display (HMD) device 200 for allowing a user to mount the head-mounted display (HMD) device 200 onto the user's head. For example, the length of the head strap 230 may be adjustable to accommodate a range of user head sizes. In some examples, the head-mounted display (HMD) device 200 may include additional, fewer, and/or different components such as a display 210 to present a wearer augmented reality (AR)/virtual reality (VR) content and a camera to capture images or videos of the wearer's environment.

As shown in the bottom perspective view of diagram 200B of FIG. 2B, the display 210 may include one or more display assemblies and present, to a user (wearer), media or other digital content including virtual and/or augmented views of a physical, real-world environment with computer-generated elements. Examples of the media or digital content presented by the head-mounted display (HMD) device 200 may include images (e.g., two-dimensional (2D) or three-dimensional (3D) images), videos (e.g., 2D or 3D videos), audio, or any combination thereof. In some examples, the user may interact with the presented images or videos through eye tracking sensors enclosed in the body 220 of the head-mounted display (HMD) device 200. The eye tracking sensors may also be used to adjust and improve quality of the presented content.

In some examples, the head-mounted display (HMD) device 200 may include various sensors (not shown), such as depth sensors, motion sensors, position sensors, and/or eye tracking sensors. Some of these sensors may use any number of structured or unstructured light patterns for sensing purposes. In some examples, the head-mounted display (HMD) device 200 may include an input/output interface for communicating with a console communicatively coupled to the head-mounted display (HMD) device 200 through wired or wireless means. In some examples, the head-mounted display (HMD) device 200 may include a virtual reality engine (not shown) that may execute applications within the head-mounted display (HMD) device 200 and receive depth information, position information, acceleration information, velocity information, predicted future positions, or any combination thereof of the head-mounted display (HMD) device 200 from the various sensors.

In some examples, the information received by the virtual reality engine may be used for producing a signal (e.g., display instructions) to the display 210. In some examples, the head-mounted display (HMD) device 200 may include locators (not shown), which may be located in fixed positions on the body 220 of the head-mounted display (HMD) device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (i.e., “eye-side”). In some examples, and as discussed herein, a projector for a display system shaped like eyeglasses may be mounted or positioned in a temple arm (i.e., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user.

In some examples, an adaptive cross-layer power and performance management service may be used in the head-mounted display (HMD) device 200. Software and hardware stacks may be accessed for gathering end-to-end knowledge of a current state of the head-mounted display (HMD) device 200, and then the service may make optimal power and thermal management decisions to achieve desired performance. As the head-mounted display (HMD) device 200 state changes, the central service may periodically reconfigure the power states of individual subsystems resulting in power and performance tradeoffs.

FIG. 3 is a perspective view of a near-eye display 300 in the form of a pair of glasses (or other similar eyewear), according to an example. In some examples, the near-eye display 300 may be a specific example of near-eye display 120 of FIG. 1 and may be configured to operate as a virtual reality display, an augmented reality (AR) display, and/or a mixed reality (MR) display.

In some examples, the near-eye display 300 may include a frame 305 and a display 310. In some examples, the display 310 may be configured to present media or other content to a user. In some examples, the display 310 may include display electronics and/or display optics, similar to components described with respect to FIGS. 1 and 2A-2C. For example, as described above with respect to the near-eye display 120 of FIG. 1, the display 310 may include a liquid crystal display (LCD) display panel, a light-emitting diode (LED) display panel, or an optical display panel (e.g., a waveguide display assembly). In some examples, the display 310 may also include any number of optical components, such as waveguides, gratings, lenses, mirrors, etc. In other examples, the display 310 may include a projector, or in place of the display 310 the near-eye display 300 may include a projector.

In some examples, the near-eye display 300 may further include various sensors on or within a frame 305. In some examples, the various sensors may include any number of depth sensors, motion sensors, position sensors, inertial sensors, and/or ambient light sensors, as shown. In some examples, the various sensors may include any number of image sensors configured to generate image data representing different fields of views in one or more different directions. In some examples, the various sensors may be used as input devices to control or influence the displayed content of the near-eye display, and/or to provide an interactive virtual reality (VR), augmented reality (AR), and/or mixed reality (MR) experience to a user of the near-eye display 300. In some examples, the various sensors may also be used for stereoscopic imaging or other similar applications.

In some examples, the pupil-replicating waveguide may be transparent or translucent to enable the user to view the outside world together with the images projected into each eye and superimposed with the outside world view. The images projected into each eye may include objects disposed with a simulated parallax, so as to appear immersed into the real-world view. The waveguide may be combined with a tunable/switchable optical element or beam steering device to provide large FOV in some implementations. In other implementations, polarization tiling, spatial tiling, and/or wavelength tiling may be used.

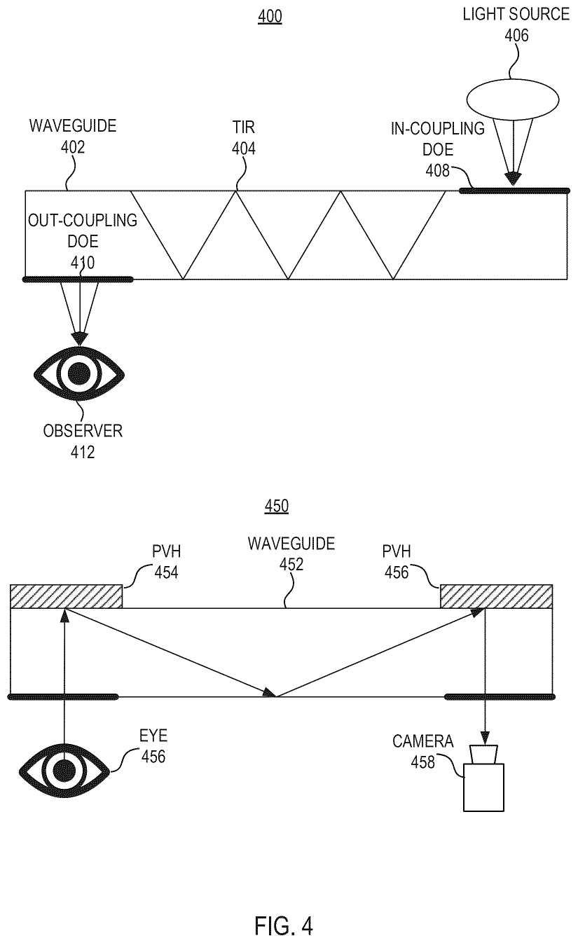

FIG. 4 illustrates a waveguide eye tracking system and a waveguide eye tracking system with polarization volume hologram (PVH) deflectors, according to an example.

As shown in diagram 400 in FIG. 4, in a waveguide architecture, light from a light source 406 (e.g., a collimated light source) may be coupled in to a waveguide 402 through an in-coupling diffractive optical element (DOE) 408. The light may propagate inside the waveguide 402 through total internal reflection (TIR) 404 and couple out through an out-coupling DOE 410 focused onto an eye (observer) 412. The in-coupling DOE 408 may provide an angle to light to ensure TIR within the waveguide 402. The out-coupling DOE 410 may focus the outgoing light onto the eye 412.

Diagram 450 in FIG. 4 shows a waveguide architecture with polarization volume hologram (PVH) reflection. In the example configuration, light from the eye 456 may couple in to the waveguide 452 and be reflected by a first PVH element 454 into the waveguide. Internally reflected light may be reflected out of the waveguide 452 by a second PVH element 456 into an eye tracking camera 458.

Waveguide FOV is critical for a waveguide eye tracking system. FOV of traditional waveguide architectures is limited by refractive index of the waveguide. By expanding FOV of the waveguide, the eye tracking system may be able to capture both high resolution small FOV image for eye tracking applications and low resolution large FOV image for face tracking applications.

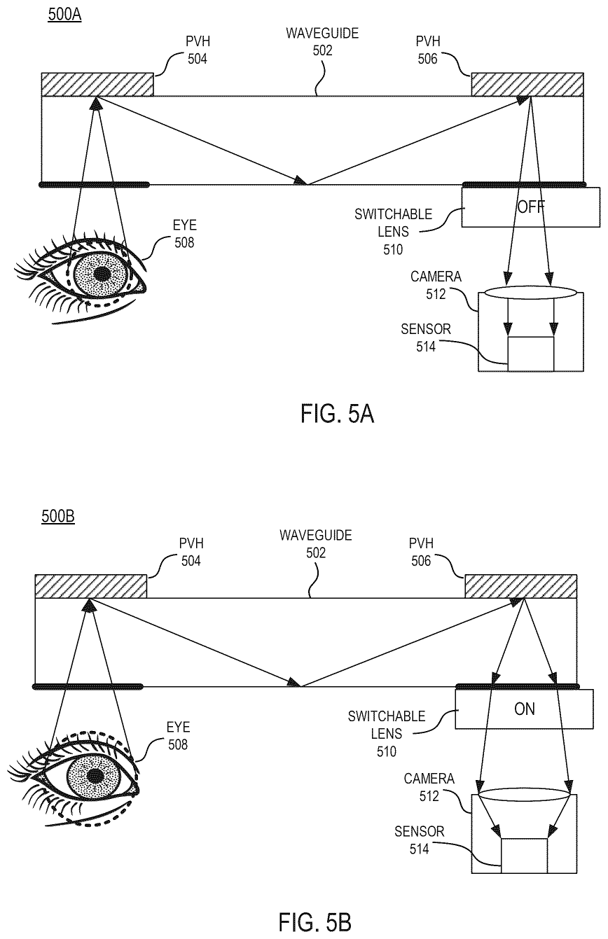

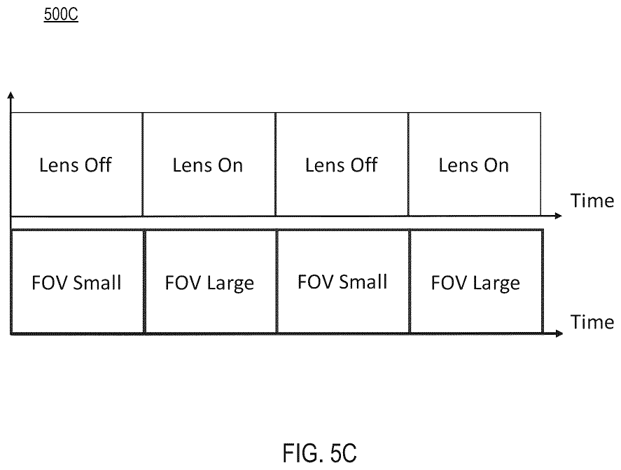

FIGS. 5A-5C illustrate a waveguide eye tracking system with a switchable/tunable optical lens, according to examples.

Diagram 500A in FIG. 5A shows a waveguide 502 receiving light from an eye 508 and internally propagating through PVH elements 504 and 506 and coupling out. At the output coupling, a switchable optical lens 510 is shown in “OFF” state allowing the light to fall onto a sensor 514 of a camera 512. IN the “OFF” state, the lens does not change the path of the out-coupled light. Thus, in order for the light to fall onto the sensor (and not exceed its perimeter), the FOV of the waveguide eye tracking system needs to be small (i.e., covering the eye only).

Diagram 500B in FIG. 5B shows the same waveguide eye tracking system configuration with the switchable optical lens 510 in “ON” state (i.e., activated). In the “ON” state, the switchable optical lens 510 may change the path of out-coupled light. The effect of the switchable optical lens 510 combined with another optical lens on the camera focusing the incoming light onto the sensor 514 may allow a larger FOV that is a (partial) face tracking may be enabled by covering the area around the eye 508.

In some examples, FOV of tracking may be small to track the eye with high resolution in one time frame, and large to track both the eye and face with lower resolution in another time frame. Diagram 500C in FIG. 5C shows alternating small and large FOV usage that may allow both accurate eye tracking and face tracking through the same system.

In some examples, the switchable optical lens may be a binary switchable optical lens (ON and OFF states only), or a multi-level switchable optical lens allowing multiple levels of FOV. In other examples, a tunable optical lens may be used in place of the switchable optical lens. Tunable optical lenses may be adjustable continuously, as opposed to the stepwise (or binary) change of state in switchable optical lenses. The switchable/tunable optical lens may include, but is not limited to, a liquid crystal (LC) gradient index (GRIN) lens, an LC Pancharatnam-Berry phase lens (PBP) lens, an LC reflective polarization volume hologram (R-PVH) lens, an LC transmissive polarization volume hologram (T-PVH) lens, a liquid lens, a meta-surface lens, a spatial light modulator (SLM), a shaped meniscus lens, and/or a hydraulically shaped lens.

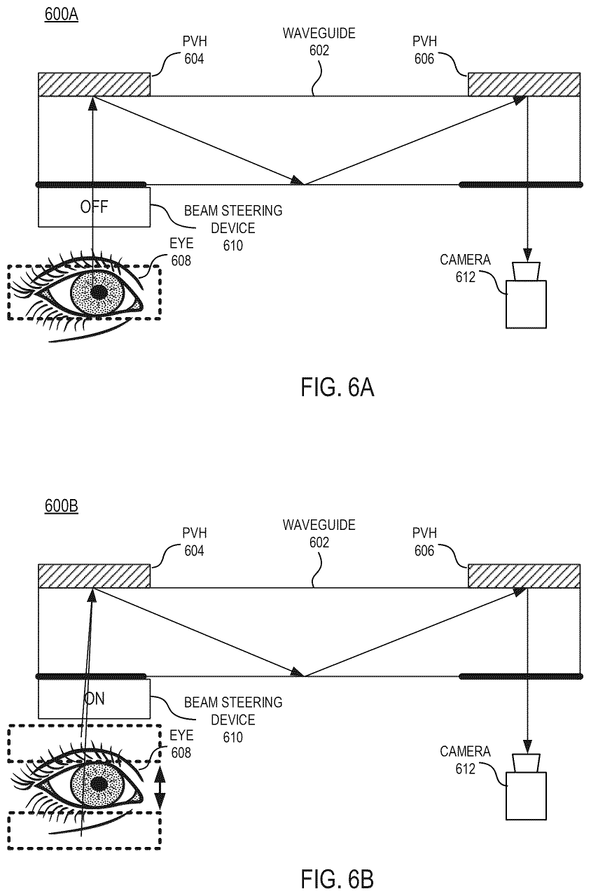

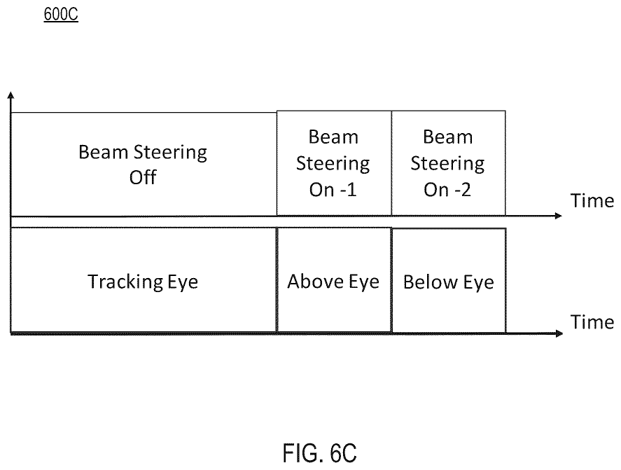

FIGS. 6A-6C illustrate a waveguide eye tracking system with a beam steering device, according to examples.

Diagram 600A in FIG. 6A shows a waveguide 602 receiving light from an eye 608 and internally propagating through PVH elements 604 and 606 and coupling out. The out-coupling light is captured by an eye tracking camera 612. At the input coupling, a beam steering device 610 is shown in “OFF” state.

The beam steering device 610 at the waveguide input coupler may allow capture of an eye image with high resolution and high quality when it is in “OFF” state. Diagram 600B in FIG. 6B shows the waveguide eye tracking system with the beam steering device 610 in “ON” state. In the “ON” state, the beam steering device 610 may change capture angle of the eye tracking system and allow capture of images of regions of the face near the eye. Thus, the beam steering device 610 may perform a quick scan in different directions to cover a large FOV with short exposure time. Thereby, a large FOV image may be captured with lower image quality.

As shown in diagram 600C in FIG. 6C, timing of the “OFF” state may be longer than the “ON” states (short bursts of beam steering vs. longer period of eye capture). Thus, higher resolution small FOV tracking of the eye may be performed with the beam steering device 610 in “OFF” state and lower resolution large FOV partial face tracking may be performed with the beam steering device 610 in “ON” states. The number of “ON” states may be selected based on waveguide, camera, and beam steering device parameters and/or computational capacity. The beam steering device 610 may include, but is not limited to, PBP grating, T-PVH grating, LC phase grating, micro-electromechanical system (MEMS), meta-surface, and/or SLM devices.

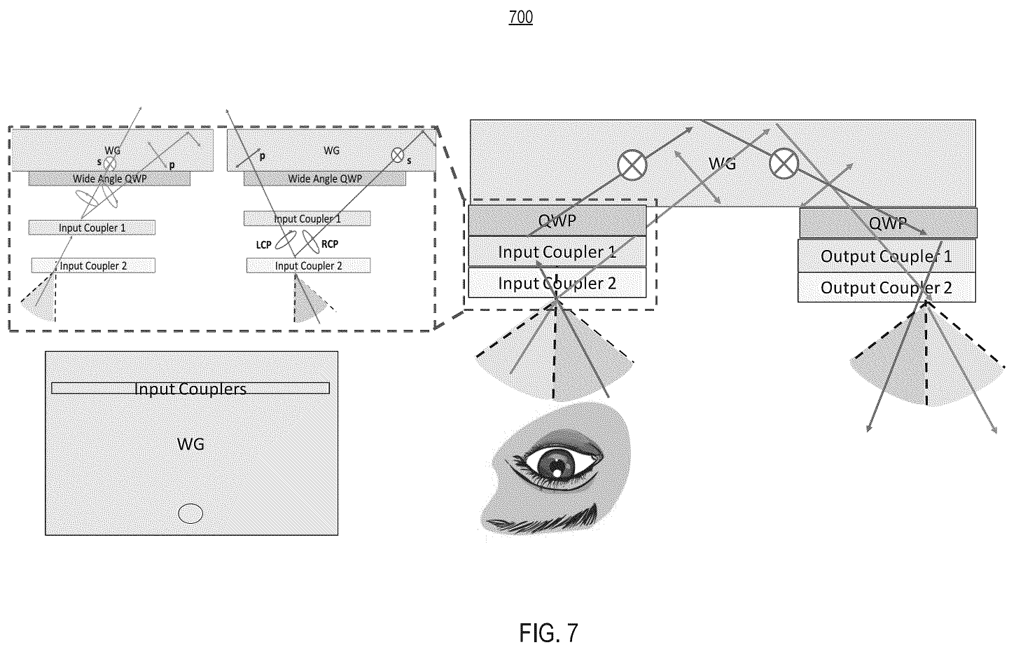

FIG. 7 illustrates an example configuration of a large field of view (FOV) waveguide eye tracking system with polarization tiling, according to an example.

To enable large FOV tracking, the waveguide itself may present another limitation. The refractive index of conventional waveguides sets up limitation of the FOV. In some examples, to enlarge FOV of the waveguide in an eye tracking system, various tiling approaches may be employed.

Diagram 700 shows a polarization tiling approach to enlarge a waveguide eye tracking system's FOV. One or more input and output couplers may be used along with polarization retarders such as quarter waveplates to provide larger FOV within standard waveguide refractive index ranges. The different input couplers may diffract differently polarized light (e.g., lefthand circularly polarized “LHCP”, righthand circularly polarized “RHCP”, linearly polarized) so that light from a wider region can propagate internally in the waveguide and couple out of the output couplers to be captured by the eye tracking camera. The input and output couplers may be stacked (along with the quarter waveplate if that is used also).

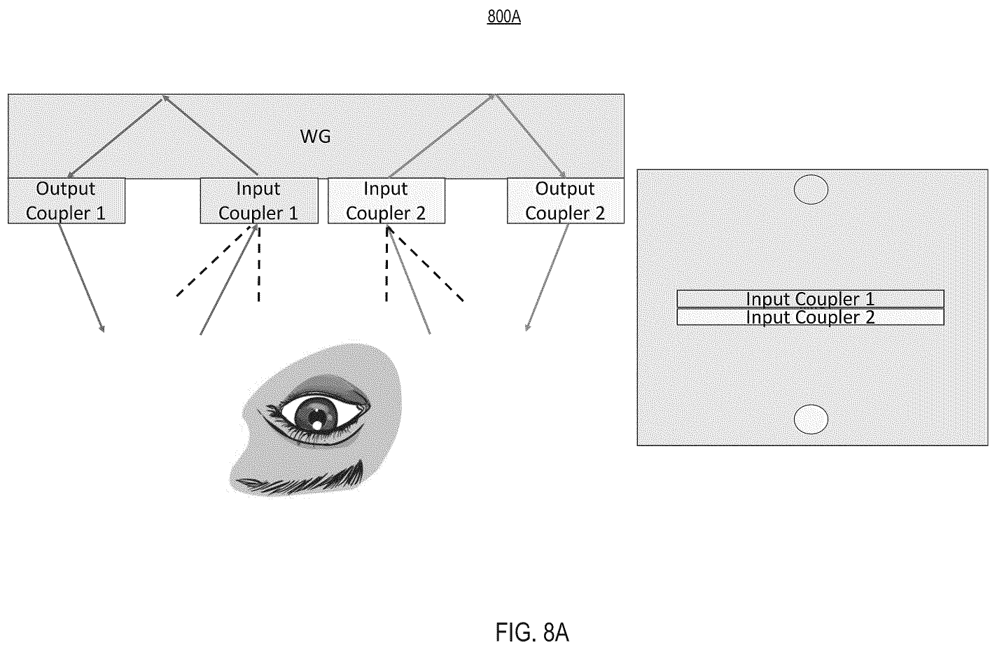

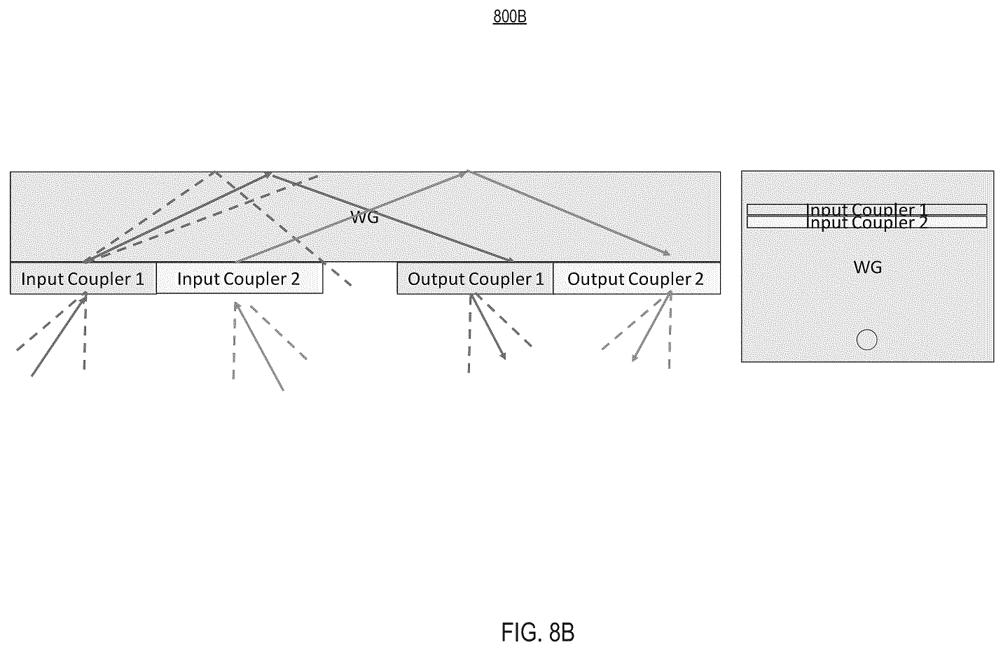

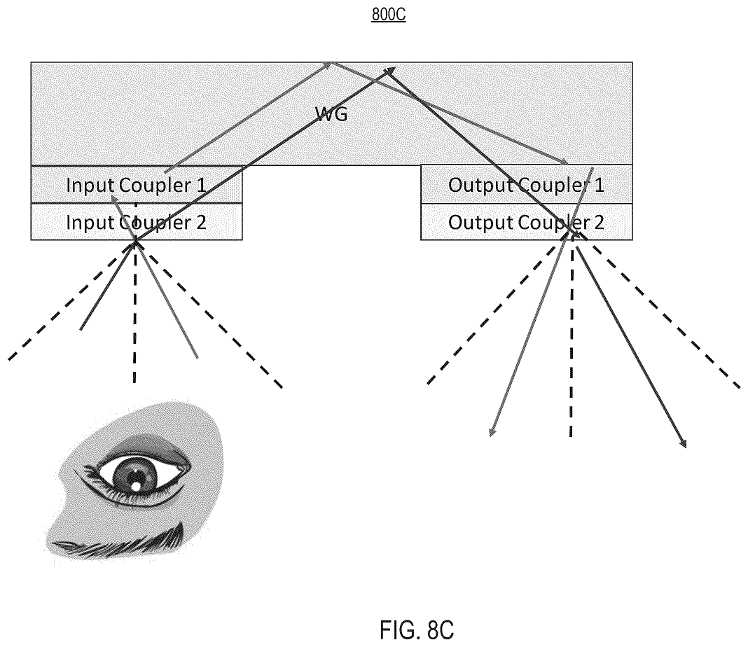

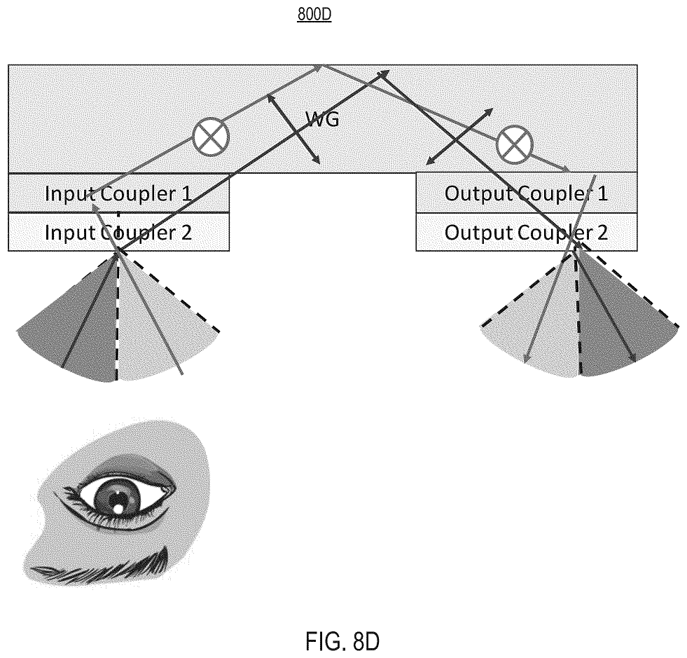

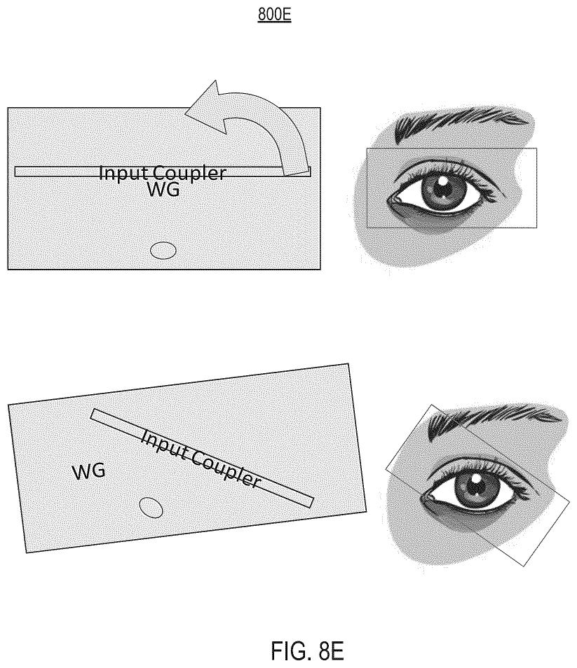

FIGS. 8A-8E illustrate example configurations of large field of view (FOV) waveguide eye tracking systems with spatial tiling, wavelength tiling, and polarization tiling, according to examples.

Diagram 800A shows an example waveguide eye tracking system configuration for spatial tiling using two pairs of input and output couplers. As shown in diagram 800A, input couplers may be placed at different locations on the waveguide in relation to their respective output couplers. Thus, each input-output coupler pair may capture and provide light from a different region allowing enlargement of the FOV beyond just the eye.

Diagram 800B shows another example waveguide eye tracking system configuration for spatial tiling using two pairs of slim input and output couplers. The configuration shown in diagram 800B is an alternative implementation, where the input couplers are paired together spatially and arranged to couple in light into the waveguide such that light from respective input couplers couples out through corresponding output couplers, again providing a larger FOV than conventional systems. To achieve the configuration shown in diagram 800B, slimmer than conventional input couplers may be needed for TIR in the waveguide.

Diagram 800C shows an example waveguide eye tracking system configuration for wavelength tiling using two pairs of input and output couplers arranged as adjacent pairs. Each of the input couplers (and output couplers) may diffract a different region of wavelengths (of the light) to provide TIR within the waveguide. Thus, light from a wider physical region may be captured (and output) by diffracting different wavelengths through different couplers.

Diagram 800D shows another example waveguide eye tracking system configuration for wavelength and polarization tiling using two pairs of input and output couplers. The configuration in diagram 800D is similar to that in diagram 800C with the difference of the input (and output) couplers providing not only wavelength tiling, but also polarization tiling. Thus, the effectiveness in enlarging the FOV of configurations in FIG. 7 and FIG. 8C may be combined. This configuration may also help reduce crosstalk and noise, which may be a challenge in using wavelength tiling by itself.

Diagram 800E in FIG. 8E shows a further approach. A shape of captured image of the eye may be substantially rectangular, thus covering areas around the eye along the longer dimension. In some examples, an orientation of the input coupler may be rotated thus changing the viewing zone. This approach may not enlarge the FOV of the eye tracking system, but it may allow for partial coverage of eyebrow and cheek areas, thus providing partial face tracking.

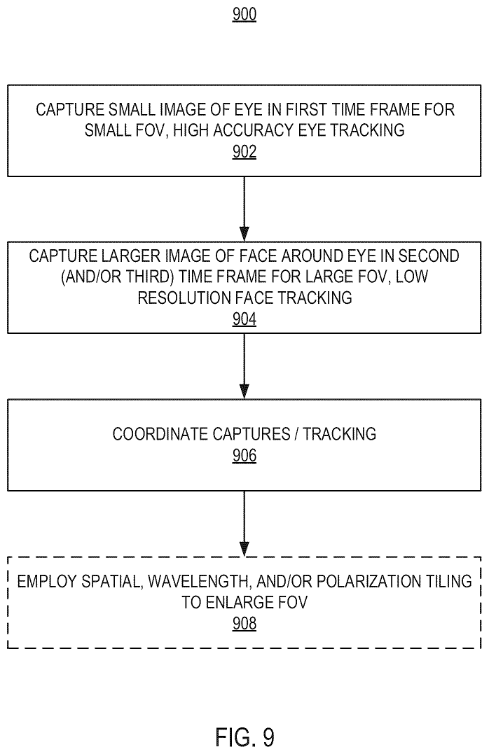

FIG. 9 illustrates a flow diagram for a method of providing large field of view (FOV) waveguide eye tracking, according to some examples. The method 900 is provided by way of example, as there may be a variety of ways to carry out the method described herein. Although the method 900 is primarily described as being performed by the components of FIGS. 5A through 8E, the method 900 may be executed or otherwise performed by one or more processing components of another system or a combination of systems. Each block shown in FIG. 9 may further represent one or more processes, methods, or subroutines, and one or more of the blocks (e.g., the selection process) may include machine readable instructions stored on a non-transitory computer readable medium and executed by a processor or other type of processing circuit to perform one or more operations described herein.

At block 902, an image of the eye may be captured for eye tracking in a first time frame, and the high resolution image may be used for high accuracy eye tracking. This may be followed by block 904, where a larger image of the area around the eye may be captured in a second time frame for large FOV, low resolution face tracking. The switch between the two captures may be accomplished by a switchable/tunable optical lens or a beam steering device turned on and off between the time frames.

At block 906, the capturing of the images and eye/face tracking may be coordinated by a controller of the eye tracking system (e.g., a processor), which may turn on or off (or adjust to a predefined level) the switchable/tunable optical lens or the beam steering device at the coordinated time points.

At optional block 908, spatial tiling, polarization tiling, and/or wavelength tiling may be employed using multiple input and/or output couplers to enlarge the FOV of the waveguide based eye tracking system. In other examples, an orientation of the eye coupler may be rotated to capture areas around the eye such as eyebrows and partial cheek without actually entering the FOV.

In some examples, the systems and methods described herein may include an eye tracking system for an augmented reality/virtual reality (AR/VR) display device, the eye tracking system, comprising a waveguide, a first deflector element to reflect captured light to propagate in the waveguide, a second deflector element to reflect the propagated light out of the waveguide, an optical element to guide out-coupled light into an eye tracking camera, wherein the optical element is to switch an operating state of the eye tracking system between a small field-of-view (FOV) state and a large FOV state, and a controller to manage the optical element such that a small FOV image of an eye is captured in a first time frame and a large FOV image of a region around the eye is captured in a second time frame. In some examples, the first deflector element and the second deflector element comprise one or more of a diffractive optical element (DOE), a holographic optical element (HOE), a free-form half reflection mirror, or a polarization volume hologram (PVH) deflector. In some examples, the optical element is a switchable optical lens, a tunable optical lens, or a beam steering device. In some examples, the beam steering device is arranged to capture a series of substantially rectangular areas around the eye.

In addition, the systems and methods described herein may include a method for eye tracking in an augmented reality/virtual reality (AR/VR) display device, comprising reflecting captured light to propagate in a waveguide, reflecting the propagated light out of the waveguide, guiding out-coupled light out of the waveguide into an eye tracking camera, including switching an operating state of the eye tracking system between a small field-of-view (FOV) state and a large FOV state, capturing a small FOV image of an eye in a first time frame, and capturing a large FOV image of a region around the eye in a second time frame. In some examples, the captured light is propagated in the waveguide via a first deflector element, and the propagated light is reflected out of the waveguide via a second deflector element. In some examples, the first deflector element and the second deflector element comprise one or more of a diffractive optical element (DOE), a holographic optical element (HOE), a free-form half reflection mirror, or a polarization volume hologram (PVH) deflector. Also, in some examples, the out-coupled light is guided out of the waveguide into the eye tracking camera via an optical element, the optical element is a switchable optical lens, and the optical element is a tunable optical lens. Furthermore, in some examples, the optical element is a beam steering device, and the optical element is a beam steering device.

In some examples, the systems and methods described herein may include a waveguide based eye tracking system for an augmented reality/virtual reality (AR/VR) display device, comprising a waveguide, a pair of input couplers to couple light from an area around an eye into the waveguide, and a pair of output couplers to couple light propagated within the waveguide out toward an eye tracking camera. In some examples, the pair of input couplers and the pair of output couplers are to enlarge a field-of-view (FOV) of the waveguide based eye tracking system. In some examples, the FOV is enlarged via one or more of spatial tiling, wavelength tiling, or polarization tiling. In some examples, the waveguide based eye tracking system further comprises a controller to capture a small FOV image of an eye in a first time frame and a large FOV image of a region around the eye in a second time frame. Moreover, in some examples, the pair of input couplers and the pair of output couplers are stacked.

According to examples, a method of making an AR/VR eye tracking system that employs a tunable/switchable optical element or a beam steering device to achieve large FOV is described herein. A system of making the AR/VR eye tracking system is also described herein. A non-transitory computer-readable storage medium may have an executable stored thereon, which when executed instructs a processor to perform the methods described herein.

In the foregoing description, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. An eye tracking system for an augmented reality/virtual reality (AR/VR) display device, the eye tracking system, comprising:
a waveguide;
a first deflector element to reflect captured light to propagate in the waveguide;
a second deflector element to reflect the propagated light out of the waveguide;
an optical element to guide out-coupled light into an eye tracking camera, wherein the optical element is to switch an operating state of the eye tracking system between a small field-of-view (FOV) state and a large FOV state; and
a controller to manage the optical element such that a small FOV image of an eye is captured in a first time frame and a large FOV image of a region around the eye is captured in a second time frame.

2. The eye tracking system of claim 1, wherein the first deflector element and the second deflector element comprise one or more of a diffractive optical element (DOE), a holographic optical element (HOE), a free-form half reflection mirror, or a polarization volume hologram (PVH) deflector.

3. The eye tracking system of claim 2, wherein the optical element is a switchable optical lens.

4. The eye tracking system of claim 2, wherein the optical element is a tunable optical lens.

5. The eye tracking system of claim 2, wherein the optical element is a beam steering device.

6. The eye tracking system of claim 5, wherein the beam steering device is arranged to capture a series of substantially rectangular areas around the eye.

7. A method for eye tracking in an augmented reality/virtual reality (AR/VR) display device, comprising:
reflecting captured light to propagate in a waveguide;
reflecting the propagated light out of the waveguide;
guiding out-coupled light out of the waveguide into an eye tracking camera, including switching an operating state of the eye tracking system between a small field-of-view (FOV) state and a large FOV state;
capturing a small FOV image of an eye in a first time frame; and
capturing a large FOV image of a region around the eye in a second time frame.

8. The method of claim 7, wherein the captured light is propagated in the waveguide via a first deflector element.

9. The method of claim 8, wherein the propagated light is reflected out of the waveguide via a second deflector element.

10. The method of claim 9, wherein the first deflector element and the second deflector element comprise one or more of a diffractive optical element (DOE), a holographic optical element (HOE), a free-form half reflection mirror, or a polarization volume hologram (PVH) deflector.

11. The method of claim 7, wherein the out-coupled light is guided out of the waveguide into the eye tracking camera via an optical element.

12. The method of claim 11, wherein the optical element is a switchable optical lens.

13. The method of claim 11, wherein the optical element is a tunable optical lens.

14. The method of claim 11, wherein the optical element is a beam steering device.

15. The method of claim 14, wherein the optical element is a beam steering device.

16. A waveguide based eye tracking system for an augmented reality/virtual reality (AR/VR) display device, comprising:
a waveguide;
a pair of input couplers to couple light from an area around an eye into the waveguide; and
a pair of output couplers to couple light propagated within the waveguide out toward an eye tracking camera.

17. The waveguide based eye tracking system of claim 16, wherein the pair of input couplers and the pair of output couplers are to enlarge a field-of-view (FOV) of the waveguide based eye tracking system.

18. The waveguide based eye tracking system of claim 17, wherein the FOV is enlarged via one or more of spatial tiling, wavelength tiling, or polarization tiling.

19. The waveguide based eye tracking system of claim 17, further comprising a controller to capture a small FOV image of an eye in a first time frame and a large FOV image of a region around the eye in a second time frame.

20. The waveguide based eye tracking system of claim 17, wherein the pair of input couplers and the pair of output couplers are stacked.
